(19) United States
(12) Patent Application Publication
(10) Pub. No.: US 2025/0212200 A1
(43) Pub. Date: Jun. 26, 2025

(54) NETWORK NODE AND METHOD IN A WIRELESS COMMUNICATIONS NETWORK

(71) Applicant: Telefonaktiebolaget LM Ericsson (publ), Stockholm (SE)

(72) Inventors: Saad Naveed Ahmed, Sundbyberg (SE); Karl Mann, Ottawa (CA)

(21) Appl. No.: 18/851,919

(22) PCT Filed: Apr. 4, 2022
(86) PCT No.: PCT/EP2022/058873

§ 371 Date: Sep. 27, 2024

(51) Int. Cl. H04W 72/12; H04B 7/06; H04B 17/309

(52) U.S. Cl. CPC H04W 72/1215; H04B 7/0626; H04B 17/309

(57) ABSTRACT

A shared spectrum is shared between at least a first RAT (radio access technology) and a second RAT. The channel measurements are for upcoming radio communications with a first User Equipment, UE, of the first RAT. The network node determines a required number of first RAT subframes for the upcoming radio communications in a next time period, and a required number of second RAT subframes for the upcoming radio communications in a next time period. Based on the determined required number of first RAT subframes and required number of second RAT subframes, the network node then distributes subframes between the first RAT and the second RAT in the shared spectrum. The number of first RAT subframes and the number of second RAT subframes are distributed such that there are sufficient first RAT subframes for the first UE to perform channel measurements for its upcoming radio communication.

### TECHNICAL FIELD

Embodiments herein relate to a network node and methods therein. In some aspects, they relate to improving channel measurements when operating in a dynamically shared spectrum in a wireless communications network.

Embodiments herein further relates to computer programs and carriers corresponding to the above methods and network node.

### BACKGROUND

In a typical wireless communication network, wireless devices, also known as wireless communication devices, mobile stations, stations (STA) and/or User Equipment (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR) or Next Generation (NG). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

### Spectrum Sharing

5G will be introduced on both new and legacy spectrum bands. This requires functionality that enables operators to plan its evolution of network assets including both spectrum bands and technologies, as well as, allow for a seamless roll-out of 5G with optimal end-user performance. A Dynamic Spectrum Sharing (DSS) solution referred to as Ericsson Spectrum Sharing (ESS) gives the possibility to introduce and add 5G within existing 4G carriers. DSS introduces intelligent, flexible, and quick 5G on low and/or mid frequency bands for wide area coverage without impacting 4G LTE. ESS software may dynamically share spectrum between 4G and 5G carriers based on traffic demand. A switch between carriers happens within milliseconds, which minimizes spectrum wastage and allows for best end-user performance.

FIG. 1 depicts 4G LTE and 5G NR sharing a spectrum in time and frequency, wherein the LTE part of the carriers is represented by white staples in the bottom of the figure, and the NR part of the carriers is represented by black staples in the top of the figure.

### LTE Cell-Specific Reference Signals (CRS)

Cell specific Reference Signals (CRS) are fundamental DL reference signals which an LTE UE uses for multiple and widely different purposes. These purposes e.g., comprise fine time and frequency synchronization, estimation of large-scale channel parameters, measurements for CSI feedback, intra and inter-frequency measurements. In addition, CRS serve as demodulation reference for receiving DL physical channels Physical Broadcast Channel (PBCH), Physical Downlink Shared Channel (PDSCH), Physical Downlink Control Channel (PDCCH), Physical Control Format Indicator Channel (PCFICH), and Physical HARQ Indicator Channel (PHICH), where HARQ means Hybrid Automatic Repeat reQuest.

FIG. 2 shows PRB grids of LTE CRS with four antenna ports and different Antenna configurations. It can be seen in the figure that a PRB grid in LTE is always occupied by CRS.

The CRS are transmitted across the entire frequency band even when DL data traffic is not present. In an LTE-NR spectrum sharing system that uses CRS rate-matching technique, these CRS act as overhead to NR and reduce NR's DL control and data channels capacity. In addition to overhead, LTE CRS from a neighbour cell act as interference towards NR PDSCH. A CRS rate-matching technique when used herein e.g., is a technique defined in 3GPP whereby NR PDSCH skips the resource elements designated for LTE CRS.

An alternative dynamic spectrum sharing technique to CRS rate-matching whereby NR cell skips the CRS Resource Elements (REs) for its PDSCH, is dynamic muting of CRS over the time-frequency resources, whereby LTE prohibits transmission of power over CRS REs so that the NR cell can transmit its PDSCH over CRS REs. Such a muting takes away LTE's CRS and potentially replaces them with NR interference.

### SUMMARY

As a part of developing embodiments herein the inventors identified a problem which first will be discussed.

FIG. 3 depicts an LTE UE interfered by ESS-NR pair cell. In FIG. 3, the NR PDSCH over CRS RE of the ESS-NR cell causes interference to the LTE UE, and the CRS Muted over NR PDSCH prohibits transmission of power over CRS REs.

This creates problem for LTE UEs which use CRS for above mentioned reasons. The accuracy of LTE serving cell's Channel State Information (CSI) and mobility measurements will also be negative impacted if measurements are done in subframes where NR is transmitting. These subframes will appear as high interference to the UE and it will report bad channel quality of the serving LTE cell.

An object of embodiments herein is to improve the performance in a multi Radio Access Technology (RAT) communications network using Spectrum Sharing.

According to an aspect, the object is achieved by a method performed by a network node. The method is for improving channel measurements when operating in a dynamically shared spectrum in a wireless communications network. The channel measurements relate to a first Radio Access Technology, RAT. The shared spectrum is shared between at least the first RAT and a second RAT. The channel measurements are for upcoming radio communications with a first User Equipment, UE, of the first RAT. The network node determines a required number of first RAT subframes for the upcoming radio communications in a next time period, and a required number of second RAT subframes for the upcoming radio communications in a next time period. Based on the determined required number of first RAT subframes and required number of second RAT subframes, the network node then distributes subframes between the first RAT and the second RAT in the shared spectrum. The number of first RAT subframes and the number of second RAT subframes are distributed such that there are sufficient first RAT subframes for the first UE to perform channel measurements for its upcoming radio communication.

According to another aspect, the object is achieved by a network node configured to improve channel measurements when operating in a dynamically shared spectrum in a wireless communications network. The channel measurements are adapted to be related to a first Radio Access Technology, RAT. The shared spectrum is shared between at least the first RAT and a second RAT. The channel measurements are for upcoming radio communications with a first User Equipment, UE, of the first RAT. The network node is further configured to:
Determine a required number of first RAT subframes for the upcoming radio communications in a next time period, and a required number of second RAT subframes for the upcoming radio communications in a next time period, and
based on the determined required number of first RAT subframes and required number of second RAT subframes, distribute subframes between the first RAT and the second RAT in the shared spectrum. The number of first RAT subframes and the number of second RAT subframes are adapted to be distributed such that there are sufficient first RAT subframes for the first UE to perform channel measurements for its upcoming radio communication.

Thanks to that the number of first RAT subframes and the number of second RAT subframes are distributed such that there are sufficient first RAT subframes for the first UE to perform channel measurements for its upcoming radio communication, an improved utilization of the radio channel is achieved via better channel measurements. This in turn results in an improved performance in a multi RAT communications network using Spectrum Sharing.

An advantages of embodiments herein at least comprises that they provide an adaptation to traffic requirements of spectrum sharing RATs.

### BIEF DESCRIPTION OF THE DRAWINGS

FIG. 1 is a schematic block diagram depicting an example of prior art.

FIG. 2 is a schematic block diagram depicting an example of prior art.

FIG. 3 is a schematic block diagram depicting an example of prior art.

FIG. 4 is a schematic block diagram depicting embodiments of a wireless communication network.

FIG. 5 is a flow chart depicting embodiments of a method in a network node.

FIG. 6 is a schematic diagram depicting an example embodiment

FIG. 7 is a schematic diagram depicting an example embodiment.

FIG. 8 is a schematic diagram depicting an example embodiment.

FIG. 9 is a schematic diagram depicting an example embodiment.

FIG. 10 is a schematic diagram depicting an example embodiment.

FIGS. 11a and b are schematic block diagrams depicting embodiments of a network node.

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

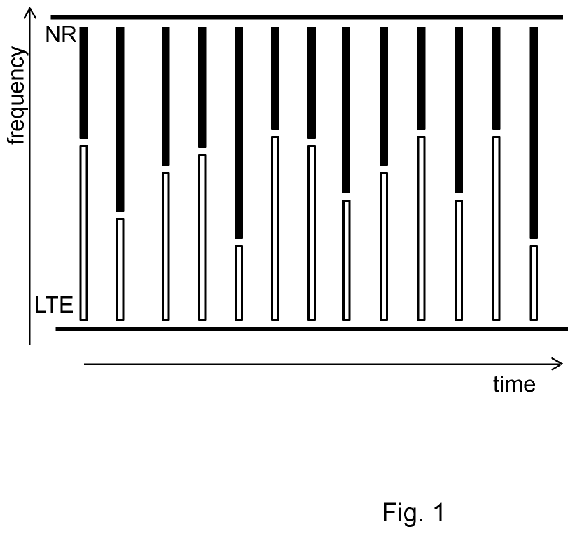

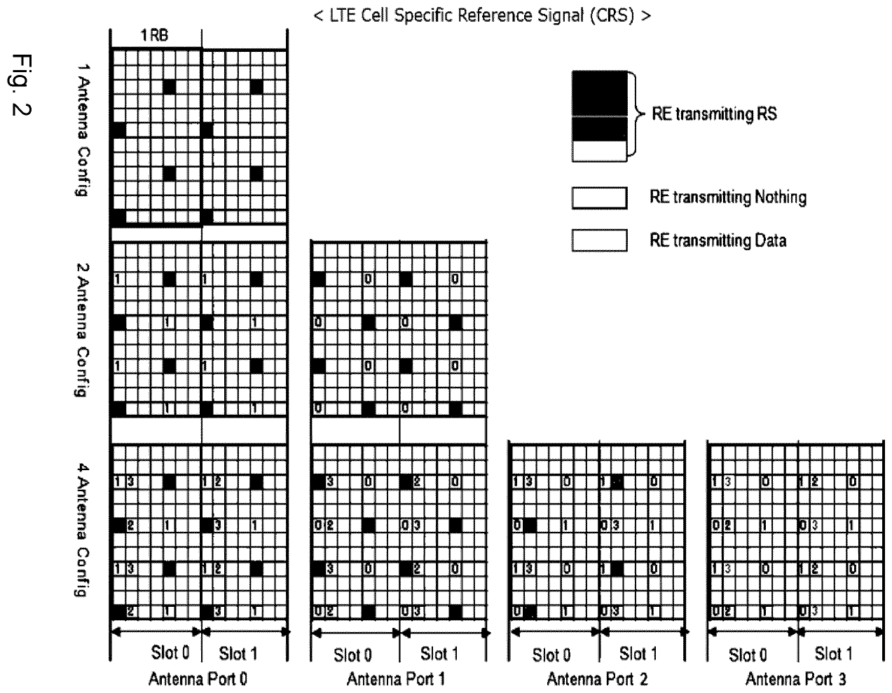

### DETAILED DESCRIPTION

Example of embodiments herein relate to channel measurements improvement of a channel related to a first RAT in DSS. E.g., embodiments relating to LTE channel measurement improvement in DSS.

A method is provided by some embodiments herein, to minimize the channel measurement problem faced by e.g. a first RAT such as LTE, due to CRS muting and second RAT, e.g., NR, interference when operating in shared spectrum mode with the second RAT, e.g. NR. In some embodiments, the method intelligently distributes resources between the first RAT and the second RAT, e.g., LTE and NR, to facilitate first RAT UEs to perform their measurements. This minimizes impact of the second RAT's PDSCH replacing CRS. Further it solves the problem that the UE uses more than one subframe to measure CQI.

Advantages of embodiments herein comprises at least an improved utilization of a radio channel via better channel estimation and adapt to traffic requirements of spectrum sharing RATs.

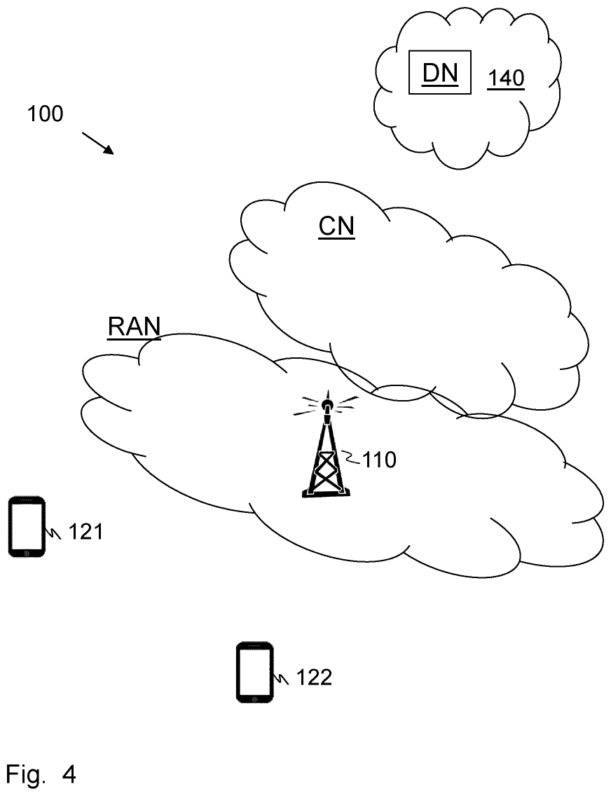

FIG. 4 is a schematic overview depicting a wireless communications network 100 wherein embodiments herein may be implemented. The wireless communications network 100 comprises one or more RANs and one or more CNs. The wireless communications network 100 may use 5 Fifth Generation New Radio, (5G NR) but may further use a number of other different Radio Access Technologies (RAT)s, such as, Wi-Fi, (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. According to some embodiments herein, a first RAT may e.g. be any one out of LTE or NR. A second RAT may e.g. be LTE if the first RAT is NR or NR if the first RAT is LTE. Further applicable RATs related to the first RAT and Second RAT may e.g. be Sixth Generation (6G), Category Machine (Cat-M), NB-IoT, GSM, CDMA, or W-CDMA.

Network nodes such as a network node 110, also referred to as the network node 110, operates in the wireless communications network 100. The network node 110 provides radio access in one or more cells by means of antenna beams. This means that the network node 110 provides radio coverage over a geographical area by means of its antenna beams. The network node 110 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within the cell served by network node 110 depending e.g. on the radio access technology and terminology used.

Wireless devices such as a first UE 121 of a first RAT, and a second UE 122 of a second RAT, operate in the wireless communications network 100. The respective UE 121, 122 may e.g. be a first RAT device, a second RAT device, an NR device, an LTE device, a mobile station, a wireless terminal, an NB-IoT device, an eMTC device, a CAT-M device, a WiFi device, an LTE device and an a non-access point (non-AP) STA, a STA, that communicates via a base station such as e.g. the network node 110, one or more Access Networks (AN), e.g. RAN, to one or more CNs. It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

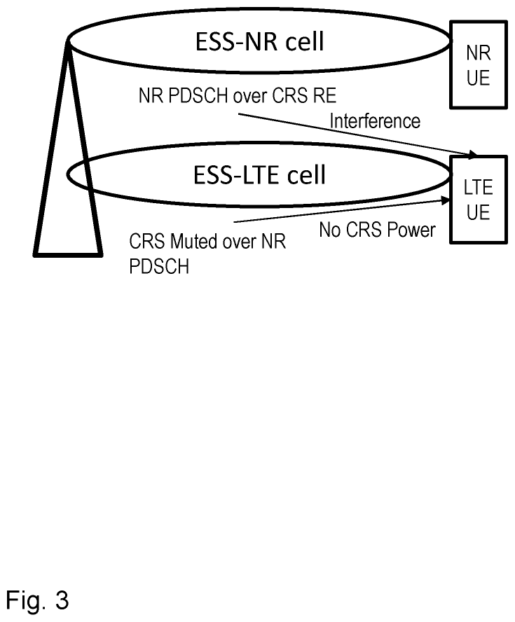

Methods herein may be performed by the network node 110. As an alternative, a Distributed Node (DN) and functionality, e.g. comprised in a cloud 140 as shown in FIG. 3, may be used for performing or partly performing the methods.

Example embodiments herein provide methods to increase accuracy of first RAT channel measurements such as e.g. in CQI reports, in a system where CRS is muted and replaced for second RAT, such as NR, efficiency.

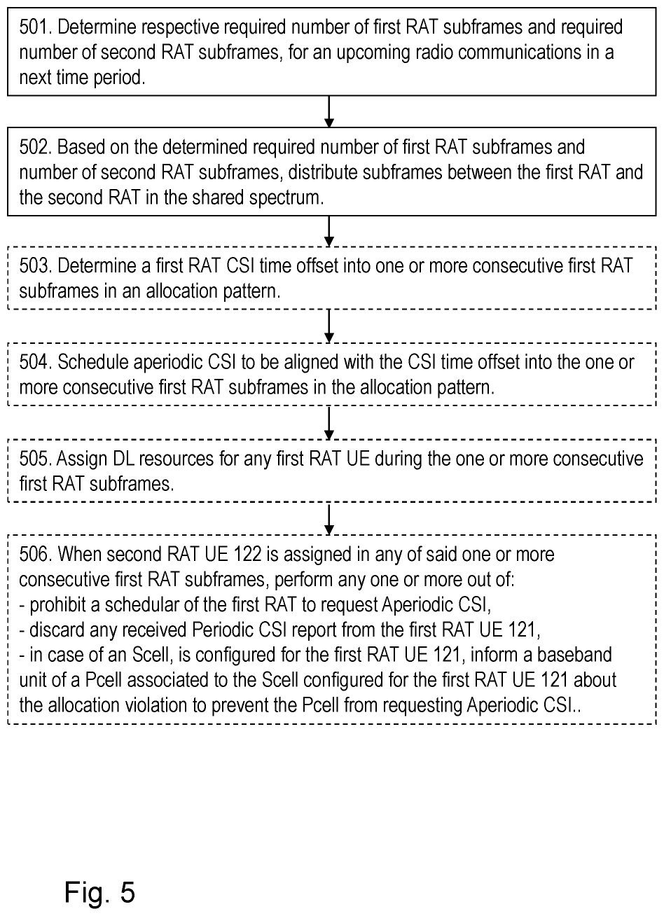

FIG. 5 shows example embodiments of a method performed by a network node 110. The method may e.g. be performed by a Shared Resource Allocator in the network node 110. The method is for improving channel measurements when operating in a dynamically shared spectrum in the wireless communications network 100. The channel measurements relate to a first RAT. The shared spectrum is shared between at least the first RAT and a second RAT. It should be noted that the shared spectrum may be shared between the first RAT, a second RAT, and more RATS, e.g. a third RAT, a fourth RAT etc. The channel measurements are for upcoming radio communications with the first UE 121 of the first RAT.

The method comprises one or more of the following actions, which actions may be taken in any suitable order. Actions that are optional are marked with dashed boxes in the figure.

### Action 501

The network node 110 determines a required number of first RAT subframes for the upcoming radio communications in a next time period, and a required number of second RAT subframes for the upcoming radio communications in a next time period.

The next time period may in an example scenario comprise at least two consecutive first RAT subframes. A next time period may e.g. mean the time period over which each RAT such as the first RAT and/or the second RAT, is assigned a number of subframes based on the radio resource needs of each RAT.

The determining of the respective required number of first RAT subframes and number of second RAT subframes for the upcoming radio communications in the next time period may be performed in different ways, such as e.g. by:
Accumulating over a decision period comprising multiple subframes, the respective required number of first RAT subframes and number of second RAT subframes,
averaging the accumulated respective required number of first RAT subframes and second RAT subframes, and
calculating the number of subframes that each respective first RAT and second RAT will be allocated over the next time period based on the averaged accumulated respective required first RAT subframes and second RAT subframes.

This will be described more in detail below.

### Action 502

Based on the determined required number of first RAT subframes and required number of second RAT subframes, the network node 110 distributes subframes between the first RAT and the second RAT in the shared spectrum. The number of first RAT subframes and the number of second RAT subframes are distributed such that there are sufficient first RAT subframes for the first UE 121 to perform channel measurements for its upcoming radio communication. Sufficient first RAT subframes for the first UE 121 to perform channel measurements may e.g., mean that one or more consecutive subframes, in some example scenarios a minimum of e.g. two consecutive subframes, are allocated to the first RAT which will give the first UE 121 enough time to be able to perform channel measurements for its upcoming radio communication.

The first RAT subframes sufficient for the first UE 121 to perform channel measurements for its upcoming radio communication may comprise one or more consecutive subframes.

The subframes may be distributed between the first RAT and the second RAT in the shared spectrum in an allocation pattern. An allocation pattern may e.g. mean the pattern of subframes in which each respective RAT will be allocated radio resources.

In some embodiments, where the subframes are distributed between the first RAT and the second RAT in the shared spectrum in an allocation pattern, the below Actions 503 and 504 may be performed.

### Action 503

In these embodiments, the network node 110 determines a first RAT CSI time offset into said one or more consecutive first RAT subframes in the allocation pattern. This may be to align the first RAT UE's measurement action with the consecutive first RAT subframes in which the measurement signals of the first RAT are likely to be without interference from the second RAT.

The assigning of the DL resources for any first RAT UE during said consecutive first RAT subframes may be performed by any one out of:
Stacking first RAT DL data traffic so that it is transmitted during said one or more consecutive first RAT subframes, or
Prohibiting transmission of the second RAT only on the resource elements used for measuring channel by first RAT during said one or more consecutive first RAT subframes. The prohibiting may be performed by using 3GPP DSS defined capabilities of rate Matching Research Set Dynamic (rateMatchingResrcSetDynamic) or separate CRS-Rate Matching Release 16 (separateCRS-RateMatching-r16) for the second RAT UE 122.

Stacking first RAT DL data traffic may mean to wait allocating resources to the first RAT thereby potentially increasing its traffic demand.

### Action 504

In these embodiments, the network node 110 schedules aperiodic CSI to be aligned with the determined CSI time offset into said one or more consecutive first RAT subframes in the allocation pattern. This means that the first RAT UE's 121 measurement action aligns with the consecutive first RAT subframes in which the measurement signals of the first RAT are likely to be without interference from the second RAT.

### Action 505

In some embodiments, the network node 110 assigns Downlink (DL) resources for any first RAT UE during said one or more consecutive first RAT subframes. This may be to align first RAT UE's measurement actions with the consecutive first RAT subframes in which the measurement signals of the first RAT are likely to be without interference from the second RAT.

### Action 506

In some embodiments, when the second RAT UE 122 is assigned in any of said one or more consecutive first RAT subframes, the network node 110 performs any one or more out of:
Prohibiting a schedular of the first RAT to request Aperiodic CSI. The network node 110 may comprise a first RAT schedular and a second RAT schedular.
Discarding any received Periodic CSI report from the first RAT UE 121.
In case of a secondary cell (Scell) is configured for the first RAT UE 121, inform a baseband unit of a Primary cell (Pcell) associated to the Scell configured for the first RAT UE 121 about the allocation violation to prevent the Pcell from requesting Aperiodic CSI.

In this way, by performing the above method, the wireless communications system's behaviour is improved improved. This is e.g. since first RAT UE 121 is likely to experience a radio channel which is interfered by the second RAT, hence a measurement during this time becomes unusable for the first RAT.

The above embodiments will now be further explained and exemplified below. The embodiments below may be combined with any suitable embodiment above.

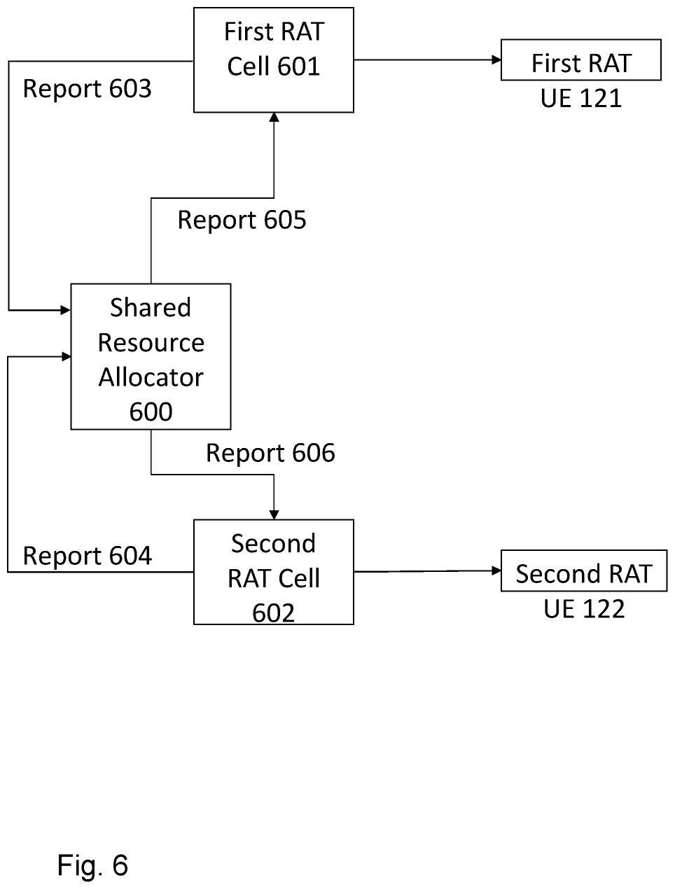

FIG. 6 is a block diagram depicting an arrangement of the network node 110 and the first RAT UE 121 and the second RAT UE 122, according to an example of embodiments herein. The network node 110 may comprise a shared resource allocator 600 for allocating resource blocks for transmissions according to embodiments herein. The network node 110 may provide first RAT cell 601 and a second RAT cell 602.

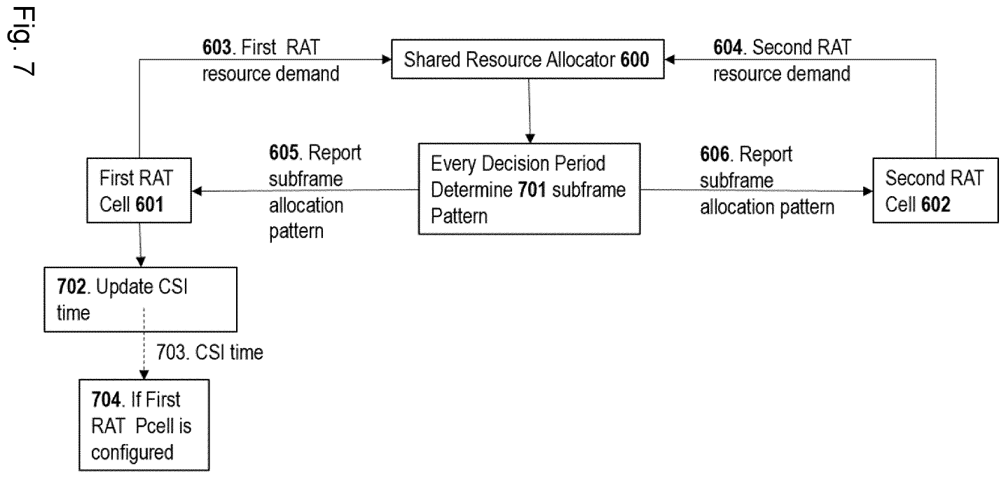

According to some embodiments herein, the network node 110 such as its Shared Resource Allocator 600 decides to and distributes, also referred to as assigns, subframes between the first and second RATs so that there are sufficient first RAT subframes to perform measurements by the first UE 121 of the first RAT. See FIG. 6 depicting the block diagram of some embodiments herein and FIG. 7 depicting an extended block diagram of some embodiments herein.

One method to determine the number of subframes for each RAT out of the first RAT and the second RAT, may be to use a resource demand of each RAT. Another method may be to manually configure allocation pattern between the first RAT and the second RAT. There may possibly be other methods, however, we describe the resource demand method in below.

Each subframe, the cells such as the first RAT cell 601 and the second RAT cell 602, report 603, 604 their resource demands to the network node 110 such as its Shared Resource Allocator 600.

Over a decision period, e.g. comprising multiple subframes, the network node 110 such as its Shared Resource Allocator 600 accumulates the demand of each RAT and then averages them:

$${PRB}_{Average}^{RAT} = \frac{{\sum }_{1}^{DecisionPeriod} {PRB}^{RAT}}{Decision Period}$$

The network node 110 such as its Shared Resource Allocator Shared resource allocator then computes the number of subframes that each RAT will be allocated over the next period:

$${Subframes}^{RAT} = \frac{{PRB}_{Average}^{RAT}}{{\sum }_{1}^{2} {PRB}_{Average}^{RAT}}$$

The network node 110 such as its Shared Resource Allocator Shared resource allocator then distributes, also referred to as arranges or decides 701, subframes between the first RAT and the second RAT so that there are sufficient LTE subframes to perform measurements. They may be decided 701 to be distributed in subframe allocation pattern.

The number of sufficient subframes may be at least two consecutive first RAT subframes each decision period.

The network node 110 such as its Shared Resource Allocator Shared resource allocator then reports 605, 606 about the distributed subframes e.g. in the subframe allocation pattern, back to the respective first RAT cell 601 and second RAT cell 602.

The network node 110, e.g. a first RAT baseband unit associated with the first RAT cell 601 provided by the network node 110, may determine a CSI time offset that corresponds to a maximum consecutive first RAT subframes in the allocation pattern, and then schedule aperiodic CSI to be aligned 801 with the determined CSI time offset into said one or more consecutive first RAT subframes in the allocation pattern. This relate to and may be combined with Actions 503 and 504 described above.

In case of a shared spectrum the first RAT cell 601 is a Secondary cell (Scell) in Carrier Aggregation (CA) configuration, the CSI time offset may be communicated 703 to the first RATs Primary cell (Pcell) 704.

When the first RAT UE 121 connects, it is assigned a periodic CSI resource with above determined offset.

The first RAT scheduler in the network node 110, schedules Aperiodic CSI so that it is aligned with the consecutive LTE subframes.

For first RAT Aperiodic CSI, it is ensured that Aperiodic (A)-CSI request is prioritized enough to get scheduled at the needed time.

Shared resource allocator 600 ensures that during the decided consecutive subframes, the first RAT is assigned DL resources.

This may be achieved by stacking first RAT DL traffic so that it is transmitted during the consecutive first RAT subframes.

To handle a scenario when a second RAT is assigned in a subframe that was for a first RAT measurement, then the first RAT cell 601 may:
Prohibit requesting of Aperiodic CSI.
Discard a received Periodic CSI report.
In case of being an Scell, inform the Pcell about the allocation violation to prevent it from requesting Aperiodic CSI.

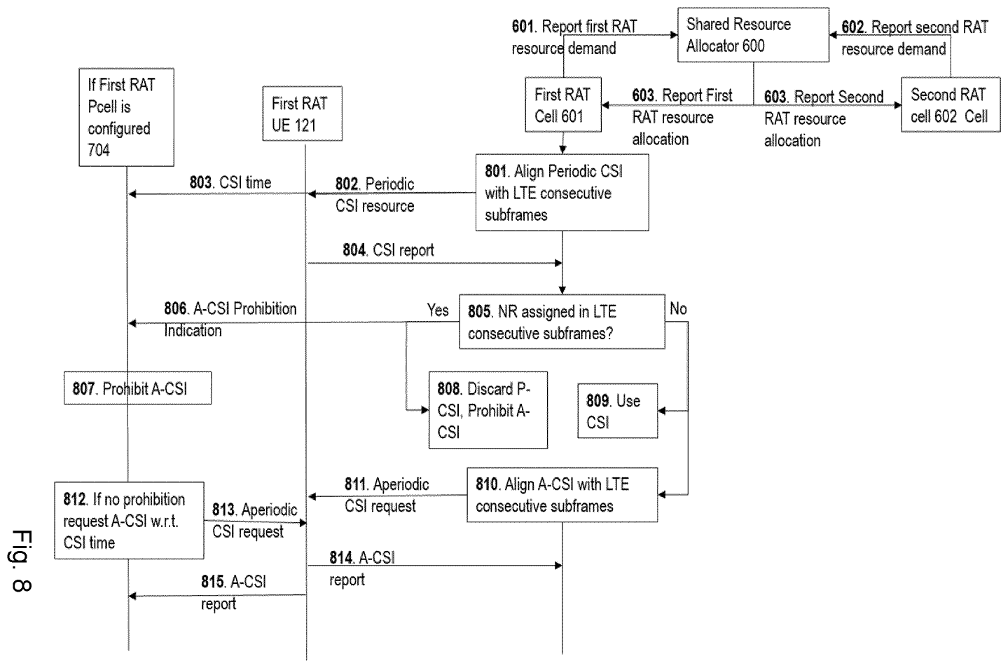

FIG. 8 depicts a furthermore extended block diagram combined with a sequence diagram of every subframe, focusing the actions performed by the first RAT and the first RAT UE 121, according to some embodiments herein.

The first RAT cell 601 aligns 801 Periodic CSI with first RAT consecutive subframes and sends 802 Periodic CSI resource to the first RAT UE 121.

The first RAT UE 121 sends 803 a CSI time to the first RAT Pcell 704 and sends 804 a CSI report to the first RAT cell 601.

The first RAT cell 601 checks 805 if second RAT is assigned in first RAT consecutive subframes.

If Yes, The first RAT cell 601 sends 806 aperiodic CSI Prohibition Indication to the first RAT Pcell 704. The first RAT Pcell 704 807 Prohibits Aperiodic A CSI.

If Yes, the first RAT cell 601 further discards 808 periodic CSI, and prohibits Aperiodic CSI.

If No, the first RAT cell 601 uses 809 CSI, aligns 810 Aperiodic CSI with first RAT consecutive subframes, and sends 811 an Aperiodic CSI request to the first RAT UE 121.

812. If no prohibition, the first RAT Pcell 704 requests 813 Aperiodic CSI with regard to CSI time from the first RAT UE 121.

The first RAT UE 121 sends 814 an Aperiodic CSI report to the first RAT cell 601 sends 814 an Aperiodic CSI report to the first RAT Pcell 704.

FIG. 9 depicts an example subframe configuration and CSI alignment when the above method according to embodiments is followed, the DSS follows the subframe assignment. Here, the first RAT is represented by LTE and the second RAT is represented by NR. Here it can be seen that LTE RAT UE 121 is assigned a consecutive number of subframes that are aligned with Periodic CSI. The LTE UE 121 experiences NR interference-free radio channel and may accurately perform its measurements. Such a measurement is then used by LTE RAT to perform link adaptation.

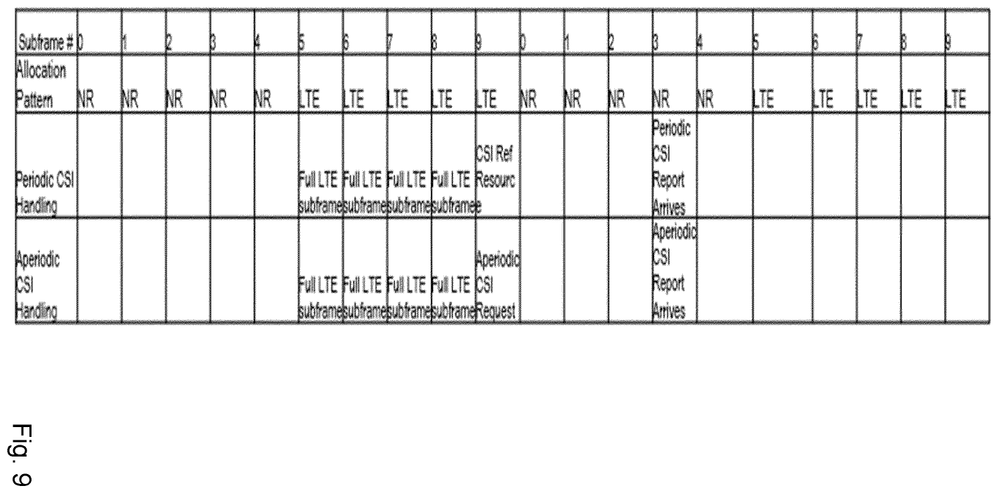

FIG. 10: depicts an example subframe configuration and CSI alignment when the DSS violates the subframe assignment. Here, the first RAT is represented by LTE and the second RAT is represented by NR. Here it can be seen that the LTE RAT UE 121 is assigned a non-consecutive number of subframes that are aligned with Periodic CSI. The LTE TAT UE 121 experiences NR interfered radio channel, and the accuracy of measurement is compromised. Such a measurement then cannot be used by LTE RAT to perform link adaptation.

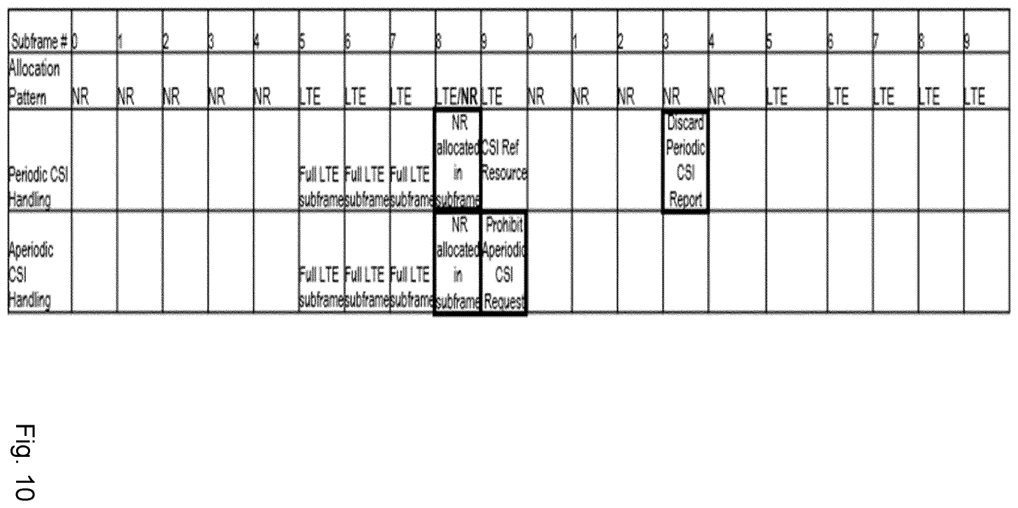

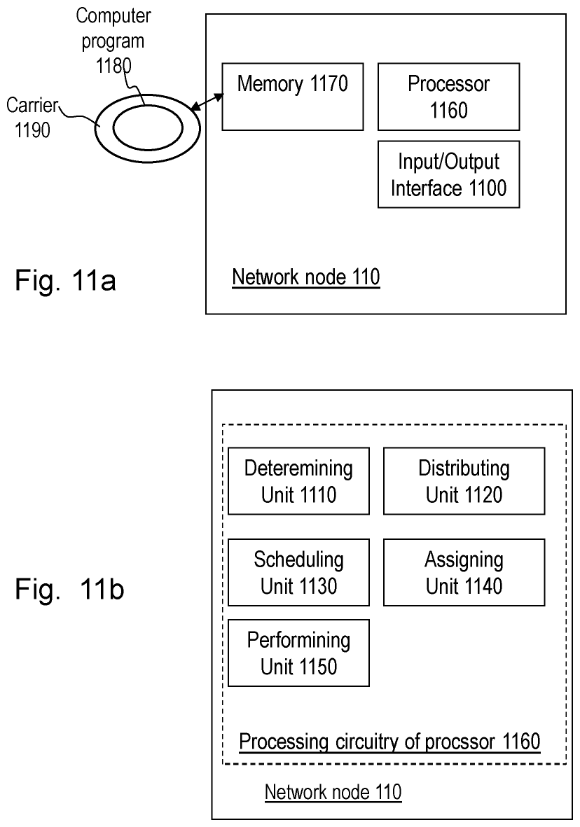

To perform the action as mentioned above, the network node 110 may comprise the arrangement as shown in FIGS. 11a and b. The network node 110 is configured to improve channel measurements when operating in a dynamically shared spectrum in the wireless communications network 100. The channel measurements are adapted to be related to the first RAT. The shared spectrum is shared between at least the first RAT and the second RAT. The channel measurements are for upcoming radio communications with the first UE 121 of the first RAT.

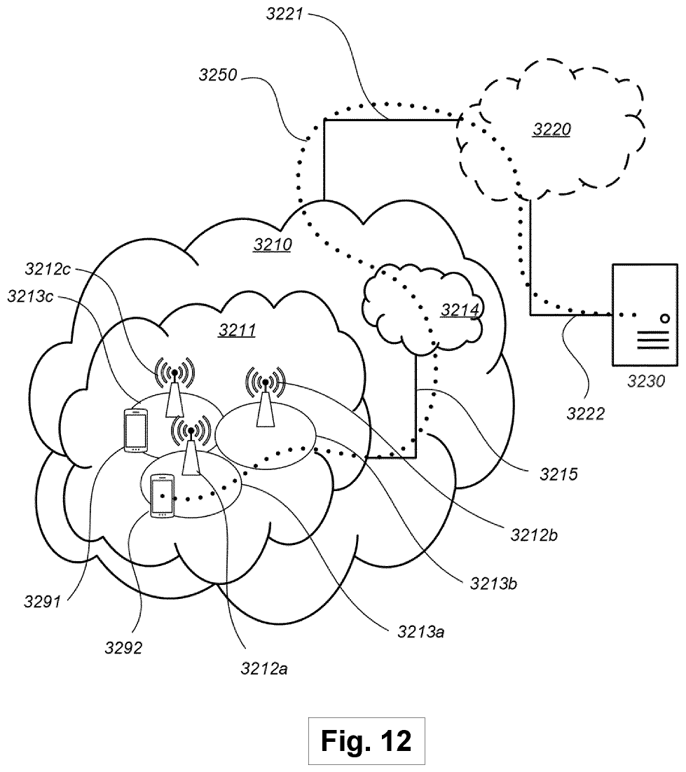

The network node 110 may comprise a respective input and output interface configured to communicate with the UEs 121, 122 see FIG. 12a. The input and output interface may comprise a wireless receiver (not shown) and a wireless transmitter (not shown).

The network node 110 is further configured to, e.g., by means of a determining unit 1110 in the network node 110, determine a required number of first RAT subframes for the upcoming radio communications in a next time period, and a required number of second RAT subframes for the upcoming radio communications in a next time period,

The network node 110 is further configured to, e.g., by means of a distributing unit 1120 in the network node 110, based on the determined required number of first RAT subframes and required number of second RAT subframes, distribute subframes between the first RAT and the second RAT in the shared spectrum. The number of first RAT subframes and the number of second RAT subframes are adapted to be distributed such that there are sufficient first RAT subframes for the first UE 121 to perform channel measurements for its upcoming radio communication.

The first RAT subframes sufficient for the first UE 121 to perform channel measurements for its upcoming radio communication may be adapted to comprise one or more consecutive subframes.

The network node 110 may further be configured to:
e.g., by means of the distributing unit 1120 in the network node 110, distribute the subframes are between the first RAT and the second RAT in the shared spectrum in an allocation pattern,
e.g., by means of the determining unit 1110 in the network node 110, determine a first RAT Channel State Information, CSI, time offset into said one or more consecutive first RAT subframes in the allocation pattern, and
e.g., by means of a scheduling unit 1130 in the network node 110, schedule aperiodic CSI to be aligned with the determined CSI time offset into said one or more consecutive first RAT subframes in the allocation pattern.

The network node 110 may further be configured to, e.g., by means of an assigning unit 1140 in the network node 110, assign Downlink, DL, resources for any first RAT UE during said one or more consecutive first RAT subframes.

The network node 110 may further be configured to, e.g., by means of the assigning unit 1140 in the network node 110, assign of the DL resources for any first RAT UE during said consecutive first RAT subframes by any one out of:
stacking first RAT DL data traffic so that it is transmitted during said one or more consecutive first RAT subframes,
prohibiting transmission of the second RAT only on the resource elements used for measuring channel by first RAT during said one or more consecutive first RAT subframes.

The network node 110 may further be configured to, e.g., by means of the performing unit 1150 in the network node 110, when the second RAT UE 122 is assigned in any of said one or more consecutive first RAT subframes, perform any one or more out of:
prohibiting a schedular of the first RAT to request Aperiodic CSI,
discarding any received Periodic CSI report from the first RAT UE 121,
in case of a secondary cell, Scell, is configured for the first RAT UE 121 informing a baseband unit of a Primary cell, Pcell, associated to the Scell configured for the first RAT UE 121 about the allocation violation to prevent the Pcell from requesting Aperiodic CSI.

The next time period may be adapted to comprise at least two consecutive first RAT subframes.

The network node 110 may further be configured to, e.g., by means of the determining unit 1110 in the network node 110, determine respective required first RAT subframes and second RAT subframes for the upcoming radio communications in the next time by:
accumulating over a decision period comprising multiple subframes, the respective required first RAT subframes and second RAT subframes,
averaging the accumulated respective required first RAT subframes and second RAT subframes, and
calculating the number of subframes that each respective first RAT and second RAT will be allocated over the next time period based on the averaged accumulated respective required first RAT subframes and second RAT subframes.

The embodiments herein may be implemented through a respective processor or one or more processors, such as the respective processor 1160 of a processing circuitry in the network node 110, depicted in FIGS. 11a and b, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a respective memory 1170 comprising one or more memory units. Each memory comprises instructions executable by the processor 1160 in the network node 110. Each respective memory 1170 is arranged to be used to store requirements, evaluations, information, data, configurations, and applications to perform the methods herein when being executed in the network node 110.

In some embodiments, a respective computer program 1180 comprises instructions, which when executed by the at least one processor 1160, cause the at least one processor 1160 of the network node 110 to perform the actions above.

In some embodiments, a respective carrier 1190 comprises the respective computer program 1180, wherein the carrier 1190 is one of an electronic signal, an optical signal, an electromagnetic signal, a magnetic signal, an electric signal, a radio signal, a microwave signal, or a computer-readable storage medium.

Those skilled in the art will also appreciate that the units in the units described above may refer to a combination of analog and digital circuits, and/or one or more processors configured with software and/or firmware, e.g. stored in the network node 110, that when executed by the respective one or more processors such as the processors or processor circuitry described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non- limiting, i.e. meaning “consist at least of”.

The embodiments herein are not limited to the above described preferred embodiments. Various alternatives, modifications and equivalents may be used.

### Further Extensions and Variations

With reference to FIG. 12, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

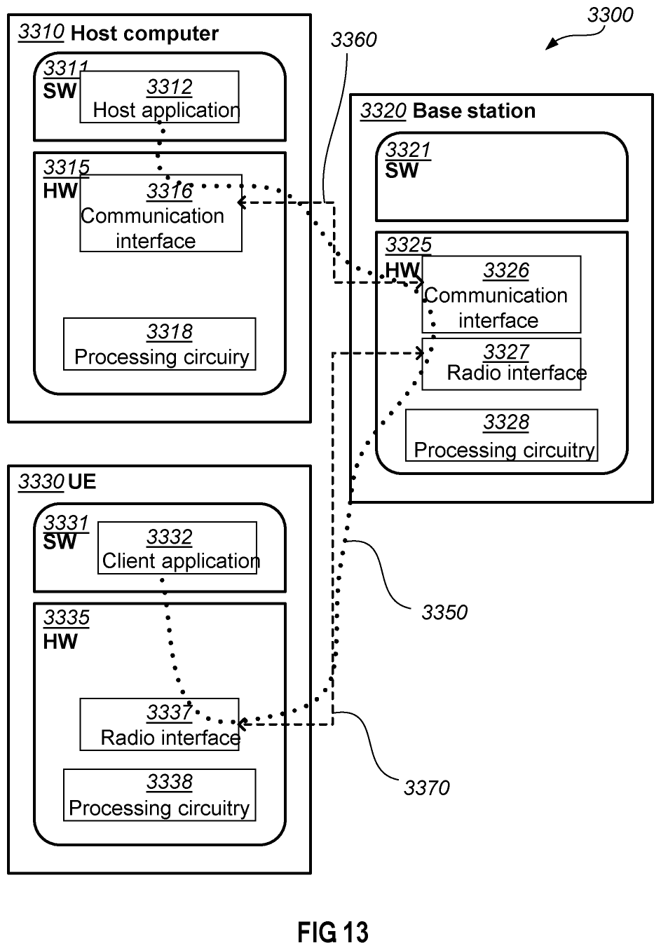

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application- specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

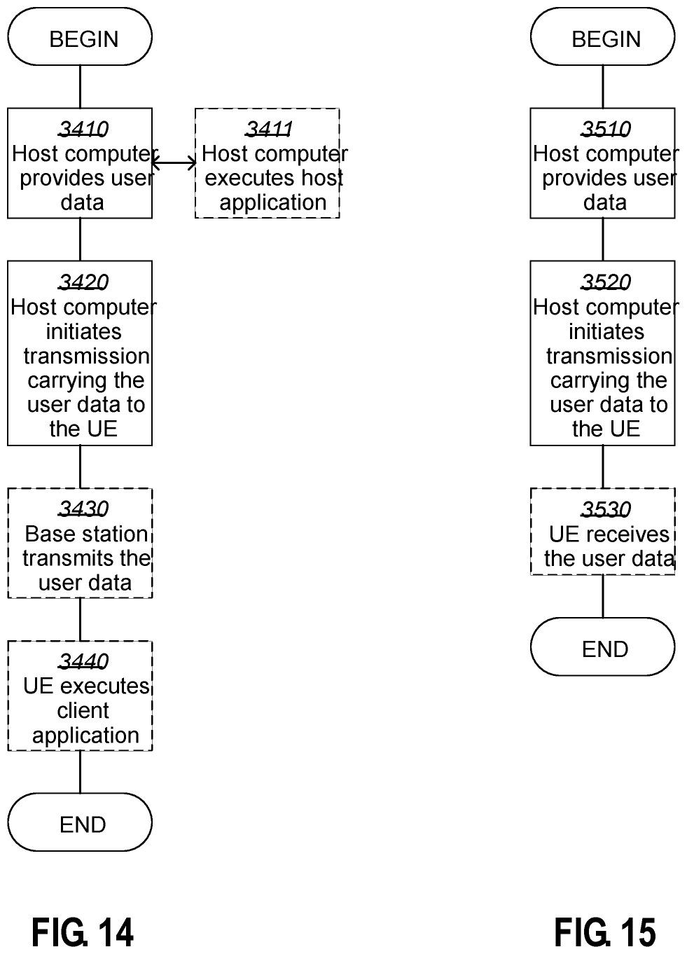

It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 14, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 14 is a flowchart illustrating a method implemented in a communication system, in accordance with one embodiment. The communication system includes a host computer, a base station such as the network node 110, and a UE such as the UE 120, which may be those described with reference to FIG. 12 and FIG. 13. For simplicity of the present disclosure, only drawing references to FIG. 14 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 15 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

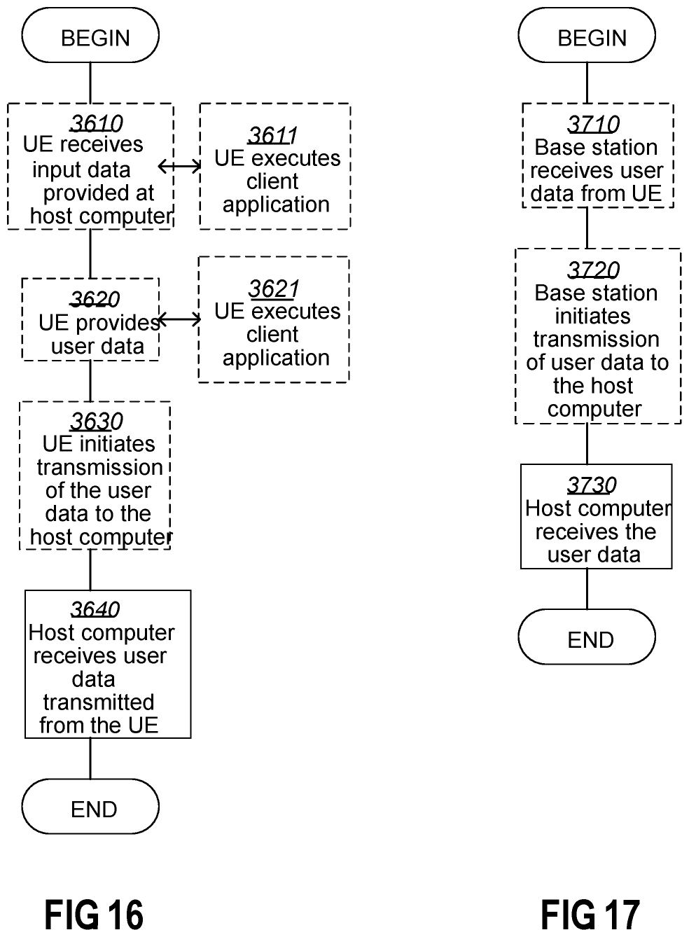

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 16 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 17 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

| Abbreviation | Explanation |
|---|---|
| CQI | Channel Quality Indicator |
| CRS | Cell-Specific Reference Signal |
| CSI | Channel State Information |
| DL | Downlink |
| DSS | Dynamic Spectrum Sharing |
| ESS | Ericsson Spectrum Sharing |
| LTE | Long term evolution |
| MAC | Medium Access Control |
| NR | Next Radio |
| PBCH | Physical Broadcast Channel |
| PCFICH | Physical Control Format Indicator Channel |
| PDCCH | Physical Downlink Control Channel |
| PDSCH | Physical Downlink Shared Channel |
| PHICH | Physical HARQ Indicator Channel |
| RAT | Radio Access Technology |
| UL | Uplink |

1. A method performed by a network node for improving channel measurements when operating in a dynamically shared spectrum in a wireless communications network, which channel measurements relate to a first Radio Access Technology, RAT, which shared spectrum is shared between at least the first RAT and a second RAT, and which channel measurements are for upcoming radio communications with a first User Equipment, UE, of the first RAT, the method comprising:
determining a required number of first RAT subframes for the upcoming radio communications in a next time period, and a required number of second RAT subframes for the upcoming radio communications in a next time period,
based on the determined required number of first RAT subframes and required number of second RAT subframes, distributing subframes between the first RAT and the second RAT in the shared spectrum,
wherein the number of first RAT subframes and the number of second RAT subframes are distributed such that there are sufficient first RAT subframes for the first UE to perform channel measurements for its upcoming radio communication.

2. The method according to claim 1, wherein the first RAT subframes sufficient for the first UE to perform channel measurements for its upcoming radio communication comprises one or more consecutive subframes.

3. The method according to claim 2, wherein the subframes are distributed between the first RAT and the second RAT in the shared spectrum in an allocation pattern, the method further comprising:
determining a first RAT Channel State Information, CSI, time offset into said one or more consecutive first RAT subframes in the allocation pattern,
scheduling aperiodic CSI to be aligned with the determined CSI time offset into said one or more consecutive first RAT subframes in the allocation pattern.

4. The method according to claim 1, further comprising:
assigning Downlink, DL, resources for any first RAT UE during said one or more consecutive first RAT subframes.

5. The method according to claim 4, wherein the assigning of the DL resources for any first RAT UE during said consecutive first RAT subframes is performed by any one out of:
stacking first RAT DL data traffic so that it is transmitted during said one or more consecutive first RAT subframes,
prohibiting transmission of the second RAT only on the resource elements used for measuring channel by first RAT during said one or more consecutive first RAT subframes.

6. The method according to claim 1, further comprising:
when the second RAT UE is assigned in any of said one or more consecutive first RAT subframes, performing any one or more out of:
prohibiting a schedular of the first RAT to request Aperiodic CSI,
discarding any received Periodic CSI report from the first RAT UE,
in case of a secondary cell, Scell, is configured for the first RAT UE informing a baseband unit of a Primary cell, Pcell, associated to the Scell configured for the first RAT UE about the allocation violation to prevent the Pcell from requesting Aperiodic CSI.

7. The method according to claim 1, wherein the next time period comprises at least two consecutive first RAT subframes.

8. The method according to claim 1, wherein the determining respective required first RAT subframes and second RAT subframes for the upcoming radio communications in the next time period is performed by:
accumulating over a decision period comprising multiple subframes, the respective required first RAT subframes and second RAT subframes,
averaging the accumulated respective required first RAT subframes and second RAT subframes, and
calculating the number of subframes that each respective first RAT and second RAT will be allocated over the next time period based on the averaged accumulated respective required first RAT subframes and second RAT subframes.

9. A computer program comprising instructions, which when executed by a processor, causes the processor to perform actions comprising:
determining a required number of first RAT subframes for an upcoming radio communications in a next time period, and a required number of second RAT subframes for the upcoming radio communications in a next time period, and
based on the determined required number of first RAT subframes and required number of second RAT subframes, distributing subframes between the first RAT and the second RAT in a shared spectrum,
wherein the number of first RAT subframes and the number of second RAT subframes are distributed such that there are sufficient first RAT subframes for a first UE to perform channel measurements for its upcoming radio communication.

10. (canceled)

11. A network node configured to improve channel measurements when operating in a dynamically shared spectrum in a wireless communications network, which channel measurements are adapted to be related to a first Radio Access Technology, RAT, which shared spectrum is shared between at least the first RAT and a second RAT, and which channel measurements are for upcoming radio communications with a first User Equipment, UE, of the first RAT, the network node further being configured to:
determine a required number of first RAT subframes for the upcoming radio communications in a next time period, and a required number of second RAT subframes for the upcoming radio communications in a next time period,
based on the determined required number of first RAT subframes and required number of second RAT subframes, distribute subframes between the first RAT and the second RAT in the shared spectrum,
wherein the number of first RAT subframes and the number of second RAT subframes are adapted to be distributed such that there are sufficient first RAT subframes for the first UE to perform channel measurements for its upcoming radio communication.

12. The network node according to claim 11, wherein the first RAT subframes sufficient for the first UE to perform channel measurements for its upcoming radio communication are adapted to comprise one or more consecutive subframes.

13. The network node according to claim 12, further being configured to:
distribute the subframes are between the first RAT and the second RAT in the shared spectrum in an allocation pattern,
determine a first RAT Channel State Information, CSI, time offset into said one or more consecutive first RAT subframes in the allocation pattern,
schedule aperiodic CSI to be aligned with the determined CSI time offset into said one or more consecutive first RAT subframes in the allocation pattern.

14. The network node according to claim 11, further being configured to:
assign Downlink, DL, resources for any first RAT UE during said one or more consecutive first RAT subframes.

15. The network node according to claim 14, further being configured to:
assign of the DL resources for any first RAT UE during said consecutive first RAT subframes by any one out of
stacking first RAT DL data traffic so that it is transmitted during said one or more consecutive first RAT subframes,
prohibiting transmission of the second RAT only on the resource elements used for measuring channel by first RAT during said one or more consecutive first RAT subframes.

16. The network node according to claim 11, further being configured to:
when the second RAT UE is assigned in any of said one or more consecutive first RAT subframes, perform any one or more out of:
prohibiting a schedular of the first RAT to request Aperiodic CSI,
discarding any received Periodic CSI report from the first RAT UE,
in case of a secondary cell, Scell, is configured for the first RAT UE
informing a baseband unit of a Primary cell, Pcell, associated to the Scell configured for the first RAT UE about the allocation violation to prevent the Pcell from requesting Aperiodic CSI.

17. The network node according to claim 11, wherein the next time period is adapted to comprise at least two consecutive first RAT subframes.

18. The network node according to claim 11, further being configured to determine respective required first RAT subframes and second RAT subframes for the upcoming radio communications in the next time by:
accumulating over a decision period comprising multiple subframes, the respective required first RAT subframes and second RAT subframes,
averaging the accumulated respective required first RAT subframes and second RAT subframes, and
calculating the number of subframes that each respective first RAT and second RAT will be allocated over the next time period based on the averaged accumulated respective required first RAT subframes and second RAT subframes.
